(19) United States
(12) Patent Application Publication
(10) Pub. No.: US 2013/0286355 A1
(43) Pub. Date: Oct. 31, 2013

(54) LIGHT FILTERING STRUCTURE AND OPTICAL ENGINE SYSTEM

(71) Applicant: DELTA ELECTRONICS, INC., Taoyuan Hsien (TW)

(72) Inventors: Chia Jui LIN, Taoyuan Hsien (TW); Tzu-Wei SU, Taoyuan Hsien (TW); Kuo-Ching CHANG, Taoyuan Hsien (TW)

(73) Assignee: DELTA ELECTRONICS, INC., Taoyuan Hsien (TW)

(21) Appl. No.: 13/674,153

(22) Filed: Nov. 12, 2012

(30) Foreign Application Priority Data
Apr. 27, 2012 (TW) 101115015

(51) Int. Cl. G03B 21/14; G02B 26/00

(52) U.S. Cl. CPC G03B 21/14; G02B 26/008
USPC 353/7; 359/889

(57) ABSTRACT

A light filtering structure and an optical engine system are provided. The light filtering structure includes a shaft center block and a first arc filter. The shaft center block is connected with an actuator to be swung back and forth by the actuator. The first arc filter is connected with the shaft center block and has an arc which corresponds with a central angle less than 360 degrees. The optical engine system includes a light source assembly, the light filtering structure and an actuator. The light source assembly produces a light beam and is disposed opposite to the light filtering structure. The actuator is connected with the shaft center block of the light filtering structure to drive the light filtering structure to swing back and forth.

### CROSS-REFERENCES TO RELATED APPLICATIONS

This application claims priority to Taiwan Patent Application No. 101115015 filed on Apr. 27, 2012, which is hereby incorporated herein by reference in their entirety.

### BACKGROUND OF THE INVENTION

1. Field of the Invention

The present invention relates a light filtering structure and an optical engine system, and more particularly, to a light filtering structure capable of swinging back and forth and an optical engine system comprising the light filtering structure capable of swinging back and forth.

2. Descriptions of the Related Art

As compared to conventional two-dimensional (2D) projection technologies, three-dimensional (3D) projection technologies (or termed as “stereoscopic projection technologies”) can make users feel as if they are within the projected images. Therefore, the 3D projection technologies are gaining increasingly more popularity from the users.

The 3D projection technologies currently used are commonly “passive 3D projection technologies of the color eyeglass type”. A projector adopting this kind of projection technologies comprises a color filter (or termed as a “color wheel”) that rotates continuously in a constant direction. The color filter has a right-eye filtering region and a left-eye filtering region. As the color filter rotates, light beams that are projected by a light source assembly of the projector alternately pass through the right-eye filtering region and the left-eye filtering region to change their wavelengths (colors). In this way, the projector can alternately output images of two different wavelengths.

Then, the left eye and the right eye of a user who wears the pair of color eyeglasses can each receive an image of one of the two wavelengths respectively. The images of the two wavelengths differ from each other in view angle slightly, and the two images are combined into a 3D image automatically by the user's brain.

However, because the color filter is unchangeable, the projector can only output 3D images but cannot output 2D images. If 2D images are desired to be outputted, a lot of time must be taken to remove the color filter so that the light beam will not be changed in wavelength by the color filter. Therefore, it is inconvenient to switch the conventional projector (or optical engine system) adopting such a rotary color filter between the output of 2D images and the output of 3D images.

In view of this, it is important to provide a light filtering structure and an optical engine system that allow a projector to switch between output of 2D images and output of 3D images conveniently.

### SUMMARY OF THE INVENTION

An objective of the present invention is to provide a light filtering structure and an optical engine system in which the light filtering structure can swing back and forth so that the projector can switch between output of 2D images and output of 3D images conveniently.

To achieve the aforesaid objective, the present invention provides a light filtering structure, which comprises a shaft center block and a first arc filter. The shaft center block is adapted to connect with an actuator to be swung back and forth by the actuator. The first arc filter is connected with the shaft center block, and has an arc which corresponds with a central angle less than 360 degrees.

To achieve the aforesaid objective, the present invention provides an optical engine system, which comprises a light source assembly, the light filtering structure and an actuator. The light source assembly is adapted to produce a light beam, while the light filtering structure is disposed opposite to the light source assembly. The actuator is connected with the shaft center block of the light filtering structure to drive the light filtering structure to swing back and forth.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic perspective view illustrating a preferred embodiment of an optical engine system of the present invention;

FIG. 2 is a front view illustrating a first embodiment of a light filtering structure of the present invention;

FIG. 3A is a schematic view (I) illustrating swinging of the light filtering structure of FIG. 2;

FIG. 3B is a schematic view (II) illustrating swinging of the light filtering structure of FIG. 2;

FIG. 3C is a schematic view (III) illustrating swinging of the light filtering structure of FIG. 2;

FIG. 3D is a schematic view (IV) illustrating swinging of the light filtering structure of FIG. 2;

FIG. 3E is a schematic view (V) illustrating swinging of the light filtering structure of FIG. 2;

FIG. 4A is a top view illustrating a second embodiment of light filtering structures of the present invention;

FIG. 4B is a front view illustrating the second embodiment of the light filtering structures of the present invention;

FIG. 4C is a top view illustrating a third embodiment of the light filtering structures of the present invention;

FIG. 4D is a top view illustrating a fourth embodiment of the light filtering structures of the present invention;

FIG. 5A is a schematic view (I) illustrating swinging of the light filtering structures of FIG. 4B;

FIG. 5B is a schematic view (II) illustrating swinging of the light filtering structures of FIG. 4B;

FIG. 5C is a schematic view (III) illustrating swinging of the light filtering structures of FIG. 4B;

FIG. 6A is a front view illustrating a fifth embodiment of the light filtering structure of the present invention;

FIG. 6B is a schematic view (I) illustrating swinging of the light filtering structure of FIG. 6A; and

FIG. 6C is a schematic view (II) illustrating swinging of the light filtering structure of FIG. 6A.

### DESCRIPTION OF THE PREFERRED EMBODIMENT

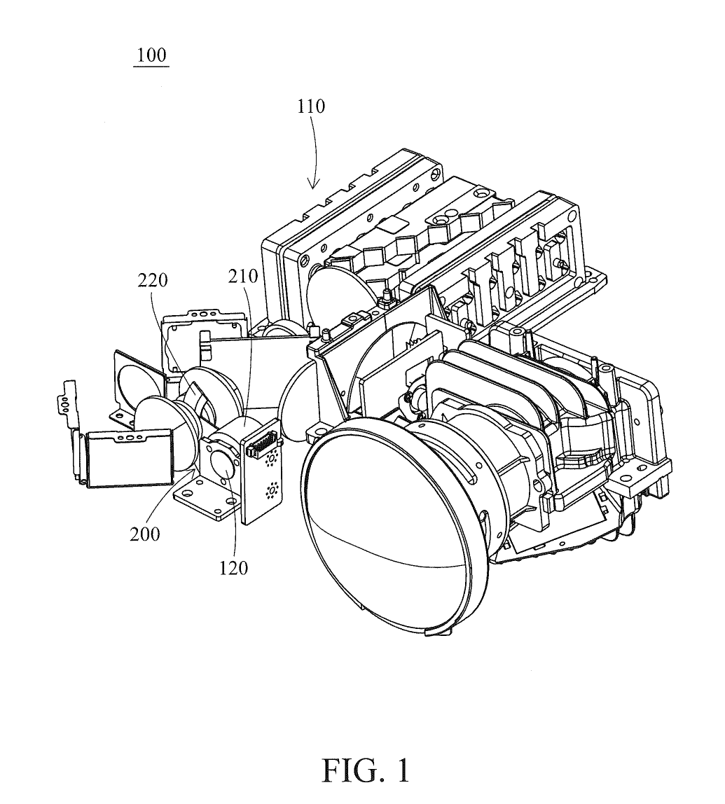

FIG. 1 illustrates a schematic perspective view of the preferred embodiment of an optical engine system of the present invention. The optical engine system 100 can be used in a projector to provide a light for a light valve (e.g., a digital micromirror device, not shown) of the projector.

The optical engine system 100 may comprise a light source assembly 110, a light filtering structure 200 and an actuator 120. The light source assembly 110 is adapted to produce a light beam (not shown), and the light source assembly 110 may be a laser, a light emitting diode (LED) or a high-pressure mercury lamp. The light filtering structure 200 is disposed opposite to the light source assembly 110 so that the light beam produced by the light source assembly 110 can pass through an arc filter 220 of the light filtering structure 200. Between the light filtering structure 200 and the light source assembly 110, an optical component, such as a lens or a reflecting mirror, may be disposed to guide the light beam to pass through the arc filter 220 of the light filtering structure 200. The actuator 120 is connected with a shaft center block 210 of the light filtering structure 200 to drive the light filtering structure 200 to swing back and forth. The actuator 120 is preferred to be a driving motor.

Hereinbelow, the components and operation of the light filtering structure 200 will be further described.

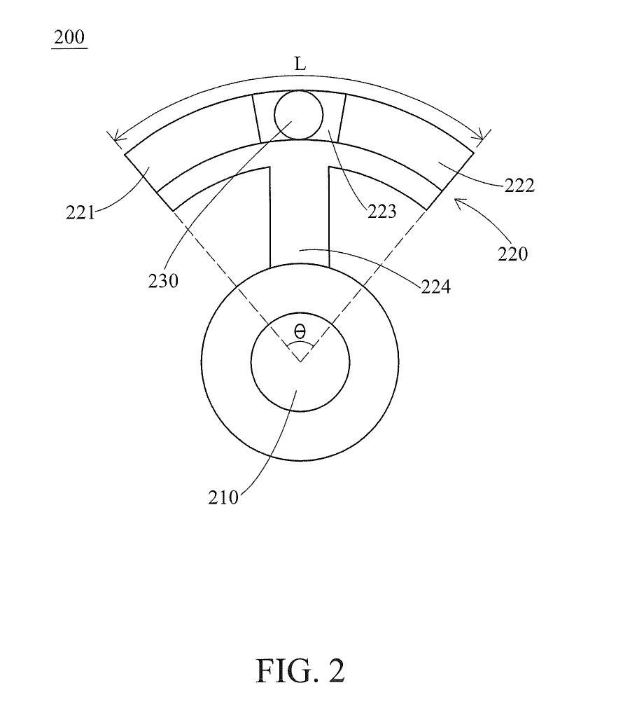

With reference to both FIGS. 1 and 2, FIG. 2 is a front view illustrating a first embodiment of the light filtering structure of the present invention. The light filtering structure 200 comprises the shaft center block 210 and the arc filter 220. The shaft center block 210 is adapted to connect with the actuator 120 to be swung back and forth by the actuator 120; that is, the actuator 120 will not rotate the shaft center block 210 continuously in a direction by a specific angle.

The arc filter 220 is adapted to be fixedly connected with the shaft center block 210 to be swung together with the shaft center block 210 by the actuator 120. In this embodiment, the light filtering structure 200 further comprises a connector 224. Two end portions of the connector 224 connect with the arc filter 220 and the shaft center block 210 respectively; that is, the arc filter 220 is connected with the shaft center block 210 indirectly via the connector 224. In other embodiments (not shown), the arc filter 220 may be in a fan form, and be connected to the shaft center block 210 directly.

The arc filter 220 has an arc L. Two ends of the arc L are connected to two sides of the arc filter 220 respectively, and the arc L corresponds to a central angle θ less than 360 degrees. The central angle θ is preferred to range from 3 degrees to 90 degrees; and in this embodiment, the central angle θ is equal to about 45 degrees.

The arc filter 220 may have one or more light filtering regions. In this embodiment, the arc filter 220 has a plurality of light filtering regions; that is, the arc filter 220 has a first light filtering region 221 and a second light filtering region 222. The arc filter 220 may further have a light transmission region 223, and the light transmission region 223 is disposed between the first light filtering region 221 and the second light filtering region 222 so that a boundary of the first light filtering region 221 and a boundary of the second light filtering region 222 do not adjoin each other but are spaced from each other.

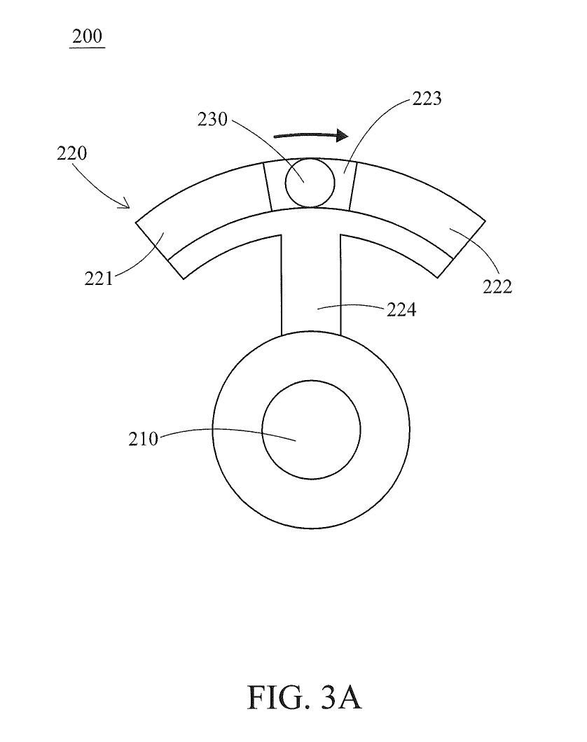

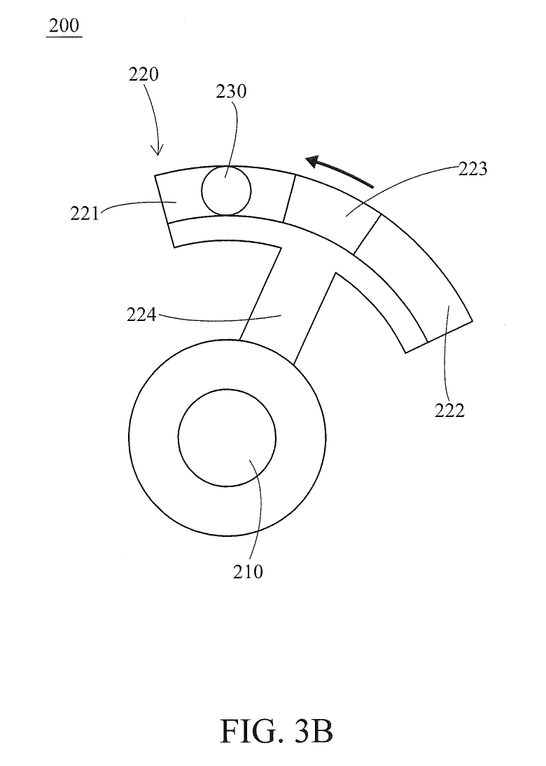

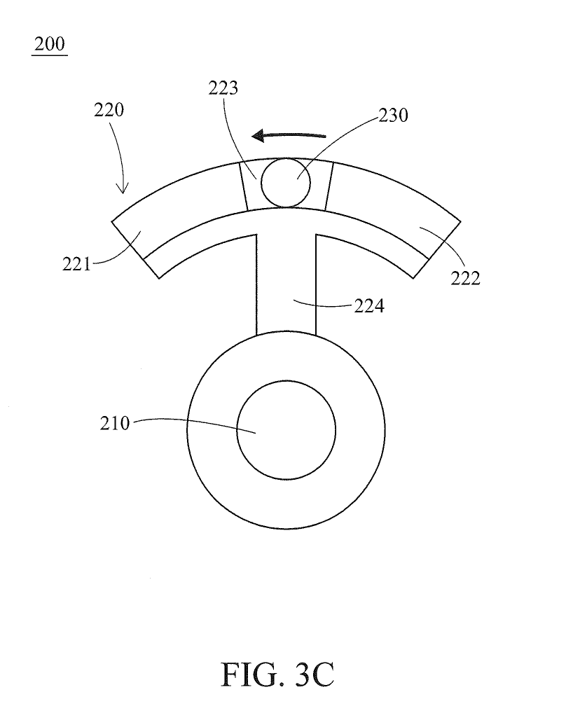

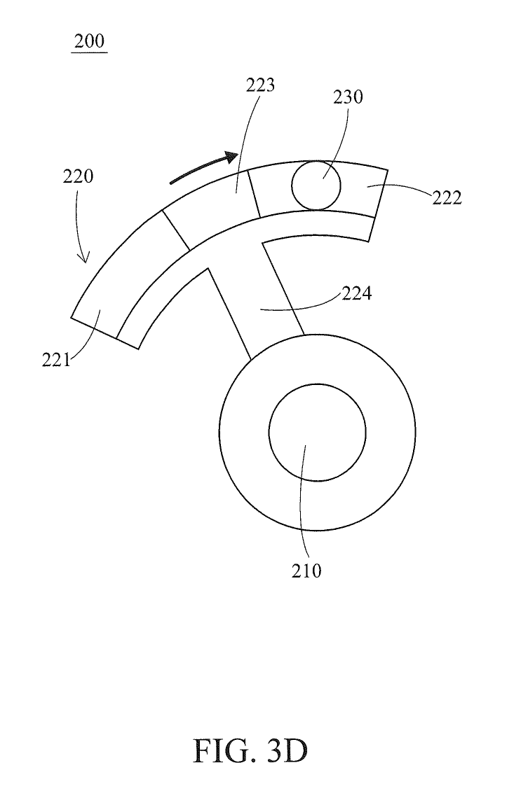

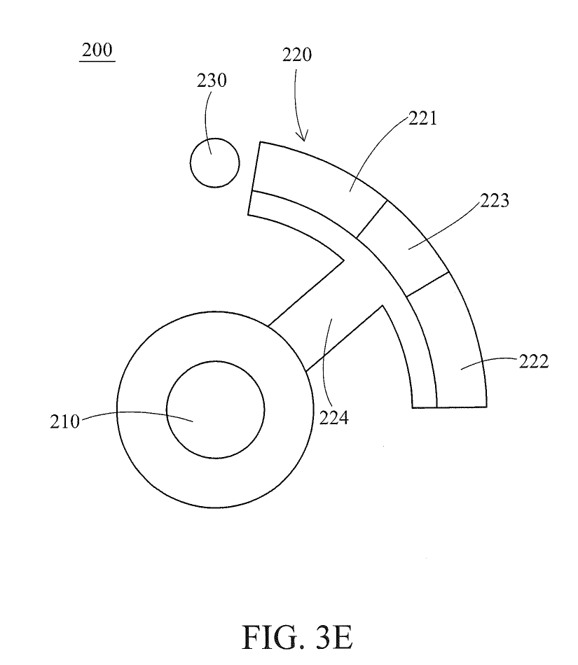

With reference to FIGS. 1 and FIGS. 3A to 3D, FIG. 3A to FIG. 3D are schematic views illustrating different swinging operations of the light filtering structure of FIG. 2 respectively. When the arc filter 220 operates, the actuator 120 will drive the shaft center block 210 and the arc filter 220 of the light filtering structure 200 to swing back and forth. As the swing angle varies, a light beam 230 produced by the light source assembly 110 passes through one of the first light filtering region 221, the second light filtering region 222 and the light transmission region 223 of the arc filter 220 so that a wavelength of the light beam 230 can be changed by the first light filtering region 221 and the second light filtering region 222.

In detail, as shown in FIG. 3A, the light beam 230 produced by the light source assembly 110 can pass through the light transmission region 223 with the wavelength thereof remaining unchanged. Then, as shown in FIG. 3B, the actuator 120 drives the shaft center block 210 to swing rightwards by an angle so that the light beam 230 passes through the first light filtering region 221. Then, as shown in FIG. 3C and FIG. 3D, the actuator 120 will not continue to drive the shaft center block 210 to swing rightwards, but drives the arc filter 220 to swing leftwards instead so that the light beam 230 passes through the light transmission region 223 and the second light filtering region 222 in sequence.

Because the arc filter 220 swings back and forth, the light beam 230 can pass through the first light filtering region 221 and the second light filtering region 222 alternately. The light beam 230 will be changed into a light beam of a specific wavelength after passing though the first light filtering region 221 and into a light beam of another specific wavelength after passing though the second light filtering region 222. The two light beams of the different wavelengths are alternately provided to the light valve (not shown) of the projector, so the projector can alternately output images of two wavelengths to allow the viewer to see a stereoscopic image.

FIG. 3E illustrates a schematic view of another swinging operation of the light filtering structure of FIG. 2. If the projector is to output a 2D image, then the actuator 120 will stop driving the arc filter 220 when the arc filter 220 has swung to a specific angle so that the light beam 230 will not pass through any region of the arc filter 220. In this way, the wavelength of the light beam 230 will not be changed by the arc filter 220 so that the projector can output the 2D image. As can be known from this, by adjusting the position of the arc filter 220, the projector can be switched between output of 2D images and output of 3D images conveniently and rapidly without the need of removing the light filtering structure 200.

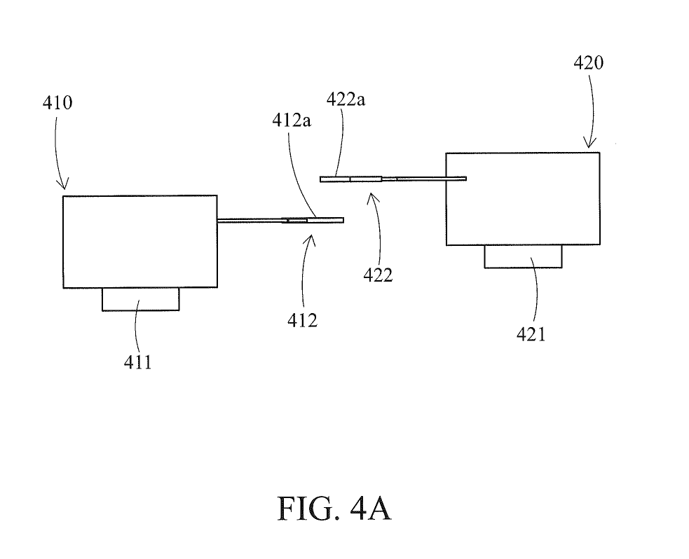

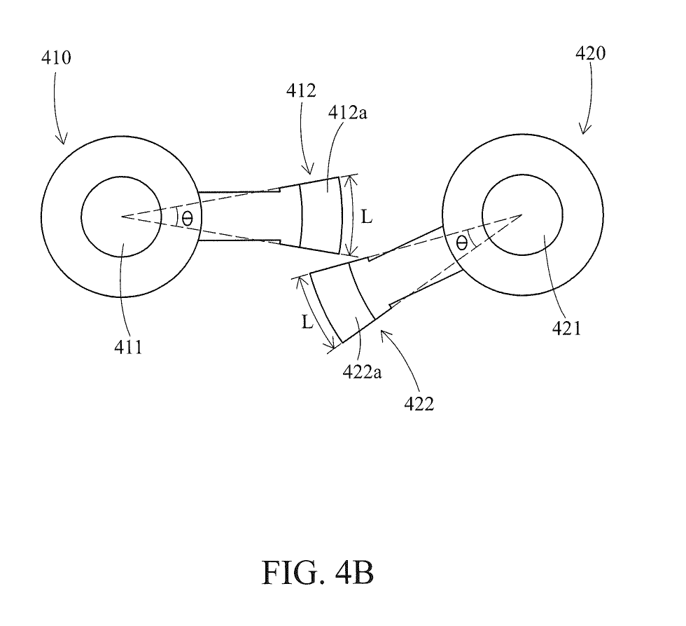

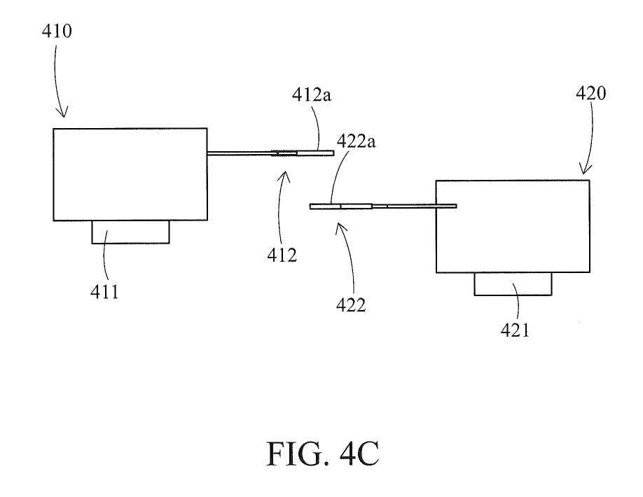

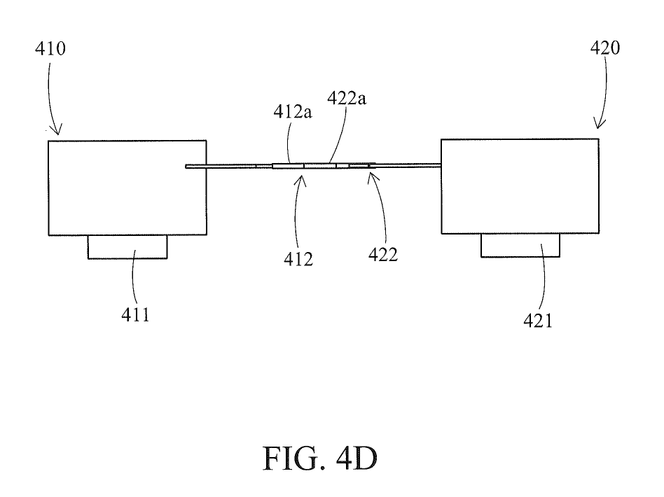

FIGS. 4A and 4B illustrate the top and front view illustrating a second embodiment of light filtering structures of the present invention respectively. The second embodiment of the present invention comprises a first light filtering structure 410 and a second light filtering structure 420, both of which can be used in the optical engine system 100 (shown in FIG. 1) to replace the light filtering structure 200.

The first light filtering structure 410 has a first shaft center block 411 and a first arc filter 412 that are connected with each other, while the second light filtering structure 420 has a second shaft center block 421 and a second arc filter 422 that are connected with each other. The first shaft center block 411 and the second shaft center block 421 may be respectively connected to two actuators (not shown) to be swung back and forth by the actuators.

The first arc filter 412 may have a first light filtering region 412a, while the second arc filter 422 may have a second light filtering region 422a. Furthermore, the first arc filter 412 may be disposed in front of the second arc filter 422. Unlike the arc filter 220 (shown in FIG. 2) of the light filtering structure 200 of the first embodiment, each of the first arc filter 412 and the second arc filter 422 has only one light filtering region 412a, 422a. The arc L of each of the first arc filter 412 and the second arc filter 422 corresponds to a relatively small central angle θ.

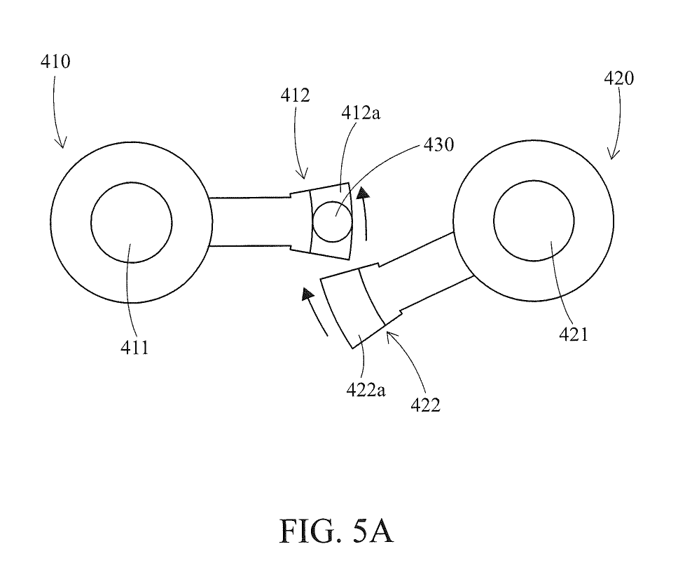

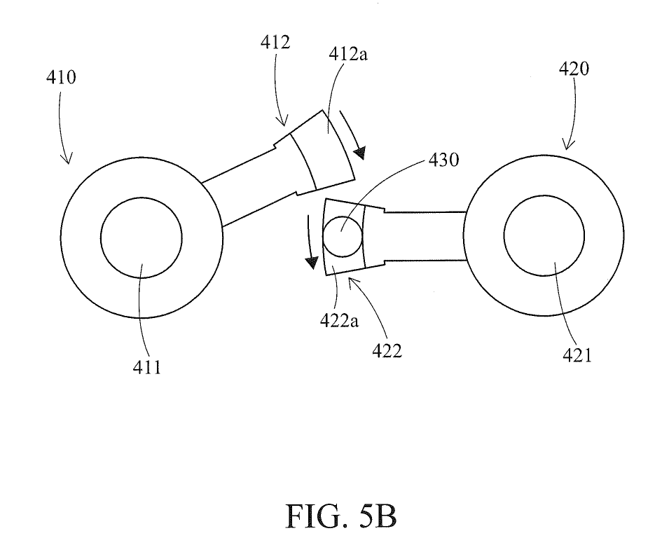

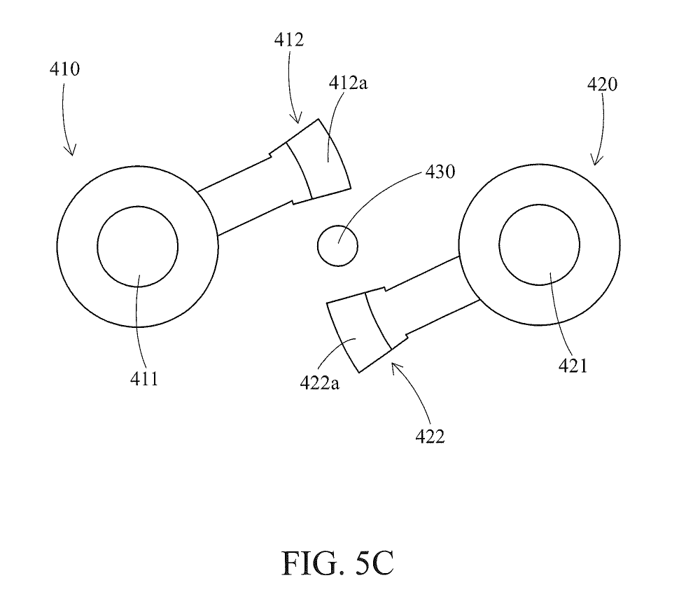

FIGS. 5A and 5B show schematic views illustrating different swinging operations of the light filtering structures of FIG. 4B respectively. When the first light filtering structure 410 and the second light filtering structure 420 operate, the actuators (not shown) drive the first arc filter 412 and the second arc filter 422 to swing back and forth so that the first arc filter 412 and the second arc filter 422 swing simultaneously in a same direction.

The first light filtering region 412a of the first arc filter 412 and the second light filtering region 422a of the second arc filter 422 are alternately moved into a light path of a light beam 430 emitted by a light source assembly (not shown) of the optical engine system so that the light beam 430 passes through the first light filtering region 412a and the second light filtering region 422a alternately. The light beam 430 will be changed into a light beam of a specific wavelength after passing though the first light filtering region 412a and into a light beam of another specific wavelength after passing though the second light filtering region 422a. The two light beams of the different wavelengths are alternately provided to the light valve (not shown) of the projector, so the projector can alternately output images of two wavelengths to allow the viewer to see a stereoscopic image.

FIG. 5C illustrates a schematic view of another swinging operation of the light filtering structures of FIG. 4B. If the projector is to output a 2D image, then the actuators will stop driving the first arc filter 412 and the second arc filter 422 when the first arc filter 412 and the second arc filter 422 have swung to a specific angle respectively so that the light beam 430 will not pass through the first arc filter 412 and the second arc filter 422. In this way, the wavelength of the light beam 430 will not be changed by the first arc filter 412 and the second arc filter 422 so that the projector can output the 2D image.

As can be known from this, by adjusting the positions of the two arc filters 412 and 422, the projector can be switched between output of 2D images and output of 3D images conveniently and rapidly without the need of removing the two light filtering structures 410 and 420.

FIG. 4C illustrates the top view of a third embodiment of the light filtering structures of the present invention. The two light filtering structures 410 and 420 of the third embodiment are similar to those of the second embodiment except that the first arc filter 412 of the first light filtering structure 410 of the third embodiment is disposed behind the second arc filter 422 of the second light filtering structure 420.

FIG. 4D illustrates the top view of a fourth embodiment of the light filtering structures of the present invention. The two light filtering structures 410 and 420 of the fourth embodiment are similar to those of the second embodiment except that the first arc filter 412 of the first light filtering structure 410 and the second arc filter 422 of the second light filtering structure 420 in the fourth embodiment are disposed in the same plane.

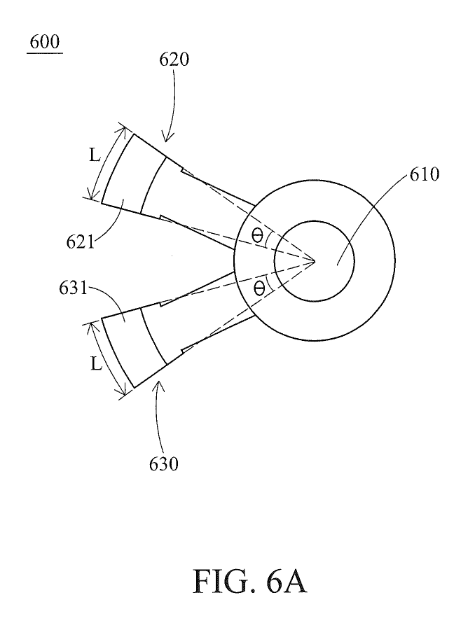

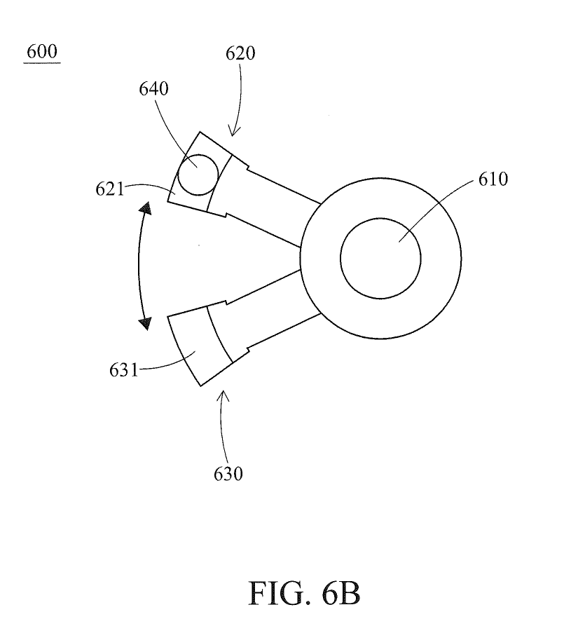

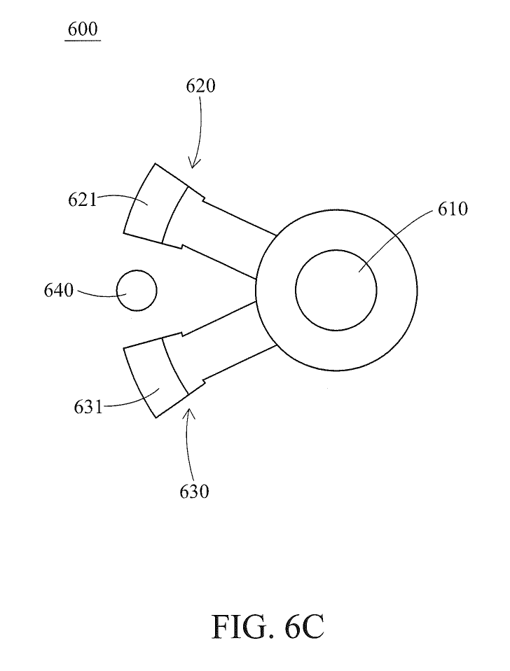

FIG. 6A illustrate the front view of a fifth embodiment of the light filtering structure of the present invention. The light filtering structure 600 can also be used in the optical engine system 100 (shown in FIG. 1) to replace the light filtering structure 200. The light filtering structure 600 may comprise a shaft center block 610, a first arc filter 620 and a second arc filter 630. The shaft center block 610 is adapted to connect with an actuator (not shown) of the optical engine system to be swung back and forth by the actuator.

The first arc filter 620 and the second arc filter 630 are connected to the shaft center block 610 respectively, and there is a gap between the first arc filter 620 and the second arc filter 630. Additionally, the first arc filter 620 has a first light filtering region 621, and the second arc filter 630 has a second light filtering region 631. Each of the first arc filter 620 and the second arc filter 630 has an arc L which corresponds to a central angle θ less than 360 degrees.

FIG. 6B illustrates a schematic view of swinging of the light filtering structure of FIG. 6A. When the light filtering structure 600 operates, the actuator drives the first arc filter 620 and the second arc filter 630 to swing back and forth and the first arc filter 620 and the second arc filter 630 swing simultaneously in the same direction.

Then, the first arc filter 620 and the second arc filter 630 are alternately moved to a light path of a light beam 640 emitted by a light source assembly (not shown) of the optical engine system so that the light beam 640 alternately passes through the first light filtering region 621 and the second light filtering region 63. The light beam 640 will be changed into a light beam of a specific wavelength after passing though the first light filtering region 621 and into a light beam of another specific wavelength after passing though the second light filtering region 631. The two light beams of the different wavelengths are alternately provided to the light valve (not shown) of the projector, so the projector can alternately output images of two wavelengths to allow the viewer to see a stereoscopic image.

FIG. 6C illustrates a schematic view of another swinging operation of the light filtering structure of FIG. 6A. If the projector is to output a 2D image, then the actuator will stop driving the first arc filter 620 and the second arc filter 630 when the first arc filter 620 and the second arc filter 630 have swung to a specific angle so that the light beam 640 will not pass through the first arc filter 620 and the second arc filter 630. In this way, the wavelength of the light beam 640 will not be changed by the first arc filter 620 and the second arc filter 630 so that the projector can output the 2D image.

According to the above descriptions, the arc filter of the light filtering structure of the present invention can swing back and forth to change the wavelength of a light beam and can stop swinging at a position so that the light beam cannot pass through the arc filter. The light filtering structure of the present invention can be used in the optical engine system of the present invention, which can be used in a projector so that the projector can switch between output of 2D images and output of 3D images rapidly and conveniently.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A light filtering structure comprising:
a shaft center block for connecting with an actuator to be swung back and forth by the actuator; and
a first arc filter, being connected with the shaft center block and having an arc which corresponds with a central angle less than 360 degrees.

2. The light filtering structure as claimed in claim 1, wherein the first arc filter has a light filtering region.

3. The light filtering structure as claimed in claim 1, wherein the first arc filter has a plurality of light filtering regions.

4. The light filtering structure as claimed in claim 3, wherein the light filtering regions comprise a first light filtering region and a second light filtering region.

5. The light filtering structure as claimed in claim 4, wherein the first arc filter further has a light transmission region, and the light transmission region is disposed between the first light filtering region and the second light filtering region.

6. The light filtering structure as claimed in claim 1, further comprising a second arc filter, wherein the second arc filter is connected with the shaft center block, and the second arc filter has an arc which corresponds with a central angle less than 360 degrees.

7. The light filtering structure as claimed in claim 6, wherein there is a gap between the first arc filter and the second arc filter.

8. The light filtering structure as claimed in claim 1, further comprising a connector, wherein two end portions of the connector connect with the first arc filter and the shaft center block respectively.

9. An optical engine system, comprising:
a light source assembly for producing a light beam;
the light filtering structure as claimed in claim 1, being disposed opposite to the light source assembly; and
an actuator, being connected with the shaft center block of the light filtering structure to drive the light filtering structure to swing back and forth.

10. The optical engine system as claimed in claim 9, wherein the actuator is a driving motor.

11. The optical engine system as claimed in claim 9, wherein the first arc filter of the light filtering structure has a light filtering region.

12. The optical engine system as claimed in claim 9, wherein the first arc filter of the light filtering structure has a plurality of light filtering regions.

13. The optical engine system as claimed in claim 12, wherein the light filtering regions comprise a first light filtering region and a second light filtering region.

14. The optical engine system as claimed in claim 13, wherein the first arc filter of the light filtering structure further has a light transmission region, and the light transmission region is disposed between the first light filtering region and the second light filtering region.

15. The optical engine system as claimed in claim 9, wherein the light filtering structure further comprises a second arc filter, the second arc filter is connected with the shaft center block, and the second arc filter has an arc which corresponds with a central angle less than 360 degrees.

16. The optical engine system as claimed in claim 15, wherein there is a gap between the first arc filter and the second arc filter.

17. The optical engine system as claimed in claim 9, further the light filtering structure further comprises a connector, wherein two end portions of the connector connect with the first arc filter and the shaft center block respectively.
